(19) United States
(12) Patent Application Publication
(10) Pub. No.: US 2026/0027477 A1
(43) Pub. Date: Jan. 29, 2026

(54) METHOD FOR CONTROLLING VIRTUAL OBJECT, COMPUTER-READABLE STORAGE MEDIUM, AND ELECTRONIC DEVICE

(71) Applicant: TENCENT TECHNOLOGY (SHENZHEN) COMPANY LIMITED, Shenzhen (CN)

(72) Inventor: Ziqi WEI, Shenzhen (CN)

(21) Appl. No.: 19/348,524

(22) Filed: Oct. 2, 2025

Related U.S. Application Data
(63) Continuation of application No. PCT/CN2024/122237, filed on Sep. 29, 2024.

(30) Foreign Application Priority Data
Dec. 28, 2023 (CN) 202311850383.7

(51) Int. Cl. A63F 13/69; A63F 13/822

(52) U.S. Cl. CPC A63F 13/69; A63F 13/822

(57) ABSTRACT

A method for controlling a virtual object applied to an electronic device includes displaying a combat area of a currently running virtual game, the virtual game being a turn-based game (TBG); displaying a first scene identifier when a first turn of the virtual game is entered, the first scene identifier being configured for indicating a first scene where the first turn is situated; and performing, in the first scene of the first turn if it is predetermined in the virtual game that a target operation is performed on at least one virtual object in the combat area, the target operation on the at least one virtual object in the combat area, the at least one virtual object being controlled by a player account.

### CROSS-REFERENCES TO RELATED APPLICATIONS

This application isa continuation application of PCT Patent Application No. PCT/CN2024/122237, filed on Sep. 29, 2024, which claims priority to Chinese Patent Application No. 2023118503837 filed on Dec. 28, 2023, all of which is incorporated herein by reference in their entirety.

### FIELD OF THE TECHNOLOGY

The present disclosure relates to the field of computer technologies, and in particular, to a method and an apparatus for controlling a virtual object, a computer-readable storage medium, a computer program product, and an electronic device.

### BACKGROUND OF THE DISCLOSURE

With the continuous development of electronic game industry, many games with different gameplay have emerged. More and more users are starting to experience various types of games through electronic devices, for example, an auto chess game.

In the related art, the main strategy of the auto chess game is that players arrange their layout by purchasing chess pieces, with the entire battlefield confined to the chessboard. Existing additional mechanisms are mostly applied to buffs that take effect on chess piece, a piece fetter, or a board grid, as well as overall buff effects. Some games have active skill mechanisms that are actively triggered within a small range. For example, active skills may be activated in certain grids to cause damage, or there are weakened-buff-type equipment with range properties at the beginning of the game.

However, in the auto chess game of related technology, only fixed and unchanging additional mechanisms exist, such as an increase in a quantity of the fetters, an additional effect of the fetter or the overall gain buff. In other words, the game mechanisms are fixed, which causes the overall gameplay to remain in repetitive combat sections, resulting in a technical problem that a virtual object is controlled in a single form/mode. If the player wants an additional game mechanism, the player needs to perform setting in each turn of every virtual game, and needs to perform resetting again when entering a next turn. This results in a complicated operation process, requiring continuous updates on resource allocation needs based on the settings of different virtual objects in each round, thereby increasing operation time, and reducing system operating efficiency.

To address the above-mentioned problems, no effective solutions have been proposed so far.

### SUMMARY

One embodiment of the present disclosure provides a method for controlling a virtual object, applied to an electronic device. The method includes displaying a combat area of a currently running virtual game, the virtual game being a turn-based game (TBG); displaying a first scene identifier when a first turn of the virtual game is entered, the first scene identifier being configured for indicating a first scene where the first turn is situated; and performing, in the first scene of the first turn if it is predetermined in the virtual game that a target operation is performed on at least one virtual object in the combat area, the target operation on the at least one virtual object in the combat area, the at least one virtual object being controlled by a player account.

Another embodiment of the present disclosure provides an electronic device. The electronic device includes one or more processors and a memory containing a computer program that, when being executed, causes the one or more processors to perform: displaying a combat area of a currently running virtual game, the virtual game being a turn-based game (TBG); displaying a first scene identifier when a first turn of the virtual game is entered, the first scene identifier being configured for indicating a first scene where the first turn is situated; and performing, in the first scene of the first turn if it is predetermined in the virtual game that a target operation is performed on at least one virtual object in the combat area, the target operation on the at least one virtual object in the combat area, the at least one virtual object being controlled by a player account.

Another embodiment of the present disclosure provides a non-transitory computer readable storage medium containing a computer program that, when being executed, causes at least one processor to perform: displaying a combat area of a currently running virtual game, the virtual game being a turn-based game (TBG); displaying a first scene identifier when a first turn of the virtual game is entered, the first scene identifier being configured for indicating a first scene where the first turn is situated; and performing, in the first scene of the first turn if it is predetermined in the virtual game that a target operation is performed on at least one virtual object in the combat area, the target operation on the at least one virtual object in the combat area, the at least one virtual object being controlled by a player account.

### BRIEF DESCRIPTION OF THE DRAWINGS

Drawings described herein are configured for providing a further understanding of the present disclosure, which constitutes a part of the present disclosure. Exemplary embodiments of the present disclosure and descriptions thereof are configured for explaining the present disclosure, and do not constitute any inappropriate limitation on the present disclosure.

FIG. 1 is a schematic diagram of an application scene of an exemplary method for controlling a virtual object according to an embodiment of the present disclosure.

FIG. 2 is a flowchart of an exemplary method for controlling a virtual object according to an embodiment of the present disclosure.

FIG. 3 is a schematic diagram (I) of an exemplary method for controlling a virtual object according to an embodiment of the present disclosure.

FIG. 4 is a schematic diagram (II) of an exemplary method for controlling a virtual object according to an embodiment of the present disclosure.

FIG. 5 is a schematic diagram (III) of an exemplary method for controlling a virtual object according to an embodiment of the present disclosure.

FIG. 6 is a schematic diagram (IV) of an exemplary method for controlling a virtual object according to an embodiment of the present disclosure.

FIG. 7 is a schematic diagram of an exemplary prohibition of using a virtual store according to an embodiment of the present disclosure.

FIG. 8 is a schematic diagram of an exemplary target operation performed on a virtual object in a preparation area according to an embodiment of the present disclosure.

FIG. 9 is a schematic diagram of another exemplary target operation performed on a virtual object in a preparation area according to an embodiment of the present disclosure.

FIG. 10 is a schematic diagram of an exemplary scene identifier switching display according to an embodiment of the present disclosure.

FIG. 11 is a schematic diagram (I) of an exemplary target operation performed on a virtual object in a combat area according to an embodiment of the present disclosure.

FIG. 12 is a schematic diagram (II) of an exemplary target operation performed on a virtual object in a combat area according to an embodiment of the present disclosure.

FIG. 13 is a schematic diagram (III) of an exemplary target operation performed on a virtual object in a combat area according to an embodiment of the present disclosure.

FIG. 14 is a schematic diagram (IV) of an exemplary target operation performed on a virtual object in a combat area according to an embodiment of the present disclosure.

FIG. 15 is an overall flowchart of an exemplary method for controlling a virtual object according to an embodiment of the present disclosure.

FIG. 16 is a schematic structural diagram of an exemplary apparatus for controlling a virtual object according to an embodiment of the present disclosure.

FIG. 17 is a schematic structural diagram of an exemplary electronic device according to an embodiment of the present disclosure.

### DESCRIPTION OF EMBODIMENTS

To enable a person skilled in the art to better under the solutions of the present disclosure, the technical solutions in embodiments of the present disclosure are clearly and completely described in the following with reference to the drawings in the embodiments of the present disclosure. Apparently, the described embodiments are merely some rather than all of the embodiments of the present disclosure. All other embodiments obtained by a person of ordinary skill in the art based on the embodiments of the present disclosure without creative efforts shall fall within the protection scope of the present disclosure.

The terms such as “first” and “second” in the specification and claims of the present disclosure and in the accompanying drawings are configured for distinguishing similar objects and not necessarily configured for describing any particular order or sequence. Data used in this way is exchangeable in a proper case, so that the embodiments of the present disclosure described herein can be implemented in another order other than those shown or described herein. In addition, the terms “include”, “have”, and any other variant thereof are intended to cover a non-exclusive inclusion. For example, a process, a method, a system, a product, or a device that includes a list of operations or units is not necessarily limited to those expressly listed operations or units, but may include other operations or units not expressly listed or inherent to the process, the method, the product, or the device.

In the embodiments of the present disclosure, the term “module” or “unit” refers to a computer program having a predetermined function or a part of a computer program, and operates together with other relevant parts to achieve a predetermined objective, and may be all or partially implemented by using software, hardware (such as a processing circuit or a memory), or a combination thereof. Similarly, one processor (or a plurality of processors or memories) may be configured to implement one or more modules or units. In addition, each module or unit may be a part of an overall module or unit including a function of the module or unit.

The technical solutions in the embodiments of the present disclosure comply with legal provisions during implementation. When an operation is performed based on the technical solutions in the embodiments, used data does not relate to user privacy, and the security of the data is ensured while it is ensured that the operation process is standard and legal.

Before the embodiments of the present disclosure are further described in detail, nouns and terms in the embodiments of the present disclosure are described, and the nouns and the terms in the embodiments of the present disclosure are applicable to the following explanations.

1) Virtual game: It refers to interactive entertainment software that simulates a reality or a fictional world running through an electronic device. The virtual game usually includes elements such as a graphic interface, a sound effect, an operation mechanism and a story line. A player may interact with the game world by using these elements, to explore, complete a task, compete, or enjoy entertainment. The virtual game may use a plurality of forms, including but not limited to any of the following: a stand-alone game, a multiplayer online game, a mobile game, a virtual reality (VR) game, and an augmented reality (AR) game.

2) Virtual object: It is a movable object in a virtual game. The movable object may be any one of the following: a virtual person, a virtual animal, and an animation person. The virtual object may be a virtual image for indicating a user in the virtual game, and may further be a user character controlled through an operation on a client. The virtual game may include a plurality of virtual objects. Each virtual object has a shape and a volume in the virtual game, and occupies some space in the virtual game.

3) A turn-based game (TBG): It is a type of game in which a game process is divided into clear turns, and a player or an entity in the game moves to an action based on a predetermined order during each round. The TBG has a plurality of types, for example, a strategic TBG, a tactical TBG, a character play TBG, or a card TBG.

4) A first scene identifier: It refers to an identifier configured for indicating a specific scene or environment in which a first turn starts in a virtual game. The identifier may be a patterned symbol, a text description, or a visual element related to the identifier, which conveys a key feature of a scene, such as virtual weather, a virtual date, or a virtual subject, so that the player can quickly identify and take an action based on the key feature. The first scene identifier includes, but is not limited to, at least one of the following: a virtual weather identifier, a virtual date identifier, and a virtual subject identifier. The virtual weather identifier represents a weather condition of the first turn, including at least one of the following: sunny, thunderstorm, frost, and typhoon, which affects attributes and skills of the virtual object in the combat area. The virtual date identifier represents a date of the first turn, for example, a holiday or a specific month, and is related to an activity, a task, or an event in the game. The virtual subject identifier represents a subject of the first turn, including at least one of the following: party, family, or vacation, which affects policy selection of a player and a game process.

5) Object attribute: It refers to a basic feature and statistical data endowed to a virtual object (such as a character, an enemy or a neutral object) in a virtual game, which determines a representation and an interaction mode of the virtual object in the game. The object attribute includes at least one of an attack value and a defense value. The attack value represents damage that can be caused when a virtual object performs an attack operation, and this value usually determines an offensive capability of the virtual object in a combat. The defense value represents damage that can be reduced when the virtual object is attacked. The value usually determines a protection capability and a viability of the virtual object.

6) Skill attribute: It refers to a specific parameter of a skill (such as a spell, a stunt, or a capability) in a virtual game, which determines a use manner and an effect of the skill. The skill attribute includes at least one of a quantity of skill release times and a skill cooling time. The quantity of skill release times represents a quantity that a virtual object is allowed to use the skill in a specific turn or time period, and the value limits a use frequency of the skill. The skill cooling time represents a time that the virtual object needs to wait after using the skill, until the virtual object can use the skill again. The time interval is configured for controlling continuous use of a skill and a game rhythm.

7) Item attribute: It refers to a feature of an item (such as a virtual weapon, an armor, or an ornament) used by a virtual object in a virtual game, which enhances a combat capability of the virtual object. The item attribute includes at least one of an item attack value and an item defense value. The item attack value represents damage that is added when the virtual object uses an item to attack, and the value is usually configured for improving attack power of the virtual object. The item defense value represents a value of reduced damage to a virtual object under protection of the item, which is usually configured for improving defensive power of the virtual object.

8) Attribute of a combination type: It refers to a synergistic effect or a combination effect that may be generated between at least one virtual object in a combat area when the virtual object satisfies a specific condition. The attribute usually involves a fetter system in the game, where a specific combination between the virtual objects may activate an additional effect or enhance certain capabilities. In a game, the fetter usually refers to a special effect generated when virtual objects with a common feature (for example, an occupation or an ethnic group) are combined together. For example, in an auto chess game, a combination of three masters may reduce magic resistance of an enemy.

9) Cloud game: It is also referred to as a gaming on demand, in other words, a game program is deployed in a server and an instance of the game program is run (referred to as a game instance for short). The game instance transmits game data outputted in a running process to a page of a browser of a user terminal, and the page invokes a media component of the browser to decode the game data, and renders a real-time game picture during the game based on a decoding result. When the page monitors an operation performed by the user in the game picture, the page reports the operation to the game instance running in the server. When game data of a response operation generated by the game instance is received, the decoding and rendering process is repeated, so that the change of the game picture based on the operation of the user is presented on the page.

In other words, the cloud game is an online game technology based on a cloud computing technology. The cloud game technology enables a thin client with relatively limited graphics processing and data computing capabilities to run a high-quality game. In the cloud game scene, the game does not run on the user terminal (for example, a player game terminal) rather than a cloud server, and the cloud server renders the game scene into an audio/video stream, and transmits the audio/video stream to the user terminal through the network. In this way, the user terminal is not required to have powerful graphics computing and data processing capabilities, but only required to have a basic streaming media playback capability and a capability of obtaining an instruction inputted by the player and transmitting the instruction to the cloud server.

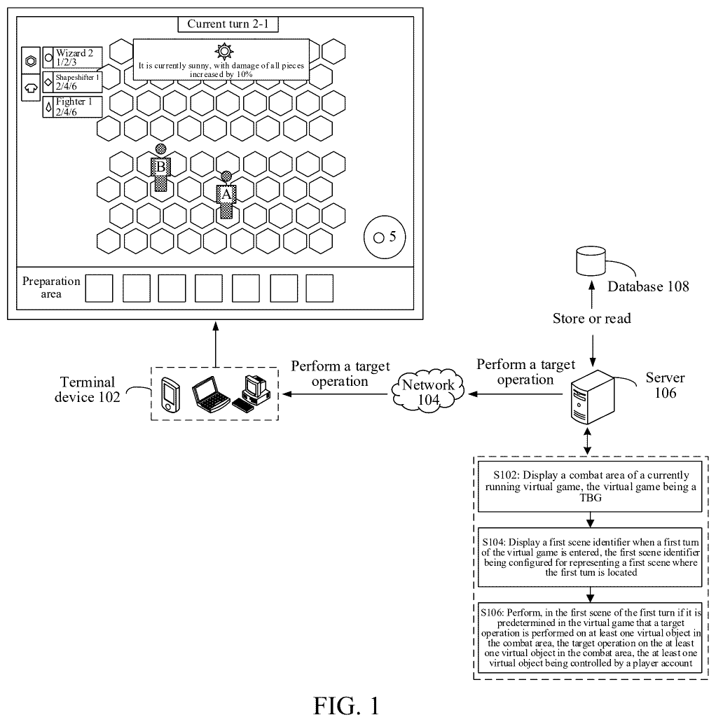

According to an aspect of the embodiments of the present disclosure, a method for controlling a virtual object is provided. In an exemplary implementation, the foregoing method for controlling a virtual object may be applied, but is not limited to, to an application scene as shown in FIG. 1. In the application scene shown in FIG. 1, a terminal device 102 may perform, but is not limited to, communication with a server 106 through a network 104, and the server 106 may perform, but is not limited to, an operation on a database 108, for example, a data write operation or a data read operation. The foregoing terminal device 102 may include, but is not limited to, a human-machine interaction screen, a processor, and a memory. The foregoing human-machine interaction screen may be, but is not limited to, a game picture of a virtual game displayed on the terminal device 102, a picture of performing a target operation on the at least one virtual object in a first turn, and the like. The foregoing processor may, but is not limited to, be configured to perform a corresponding operation in response to the foregoing human-machine interaction operation, or generate a corresponding instruction and transmit the generated instruction to the server 106. The foregoing memory is configured to store related processing data, such as a first scene identifier, a target operation, and a player account.

In some embodiments, the following operations in the method for controlling a virtual object may be performed on the server 106. Operation S102: Display a combat area of a currently running virtual game, the virtual game being a TBG. Operation S104: Display a first scene identifier when a first turn of the virtual game is entered, the first scene identifier being configured for indicating a first scene where the first turn is situated (e.g., located). Operation S106: Perform, in the first scene of the first turn if it is predetermined in the virtual game that a target operation is performed on at least one virtual object in the combat area, the target operation on the at least one virtual object in the combat area, the at least one virtual object being controlled by a player account.

In some embodiments, an example in which the virtual game is a local game is used. The following operations in the method for controlling a virtual object can be independently performed by the terminal device 102. Operation S102: Display a combat area of a currently running virtual game (or currently running round of a virtual game), the virtual game being a TBG. Operation S104: Display a first scene identifier when a first turn of the virtual game is entered, the first scene identifier being configured for indicating a first scene where the first turn is situated. Operation S106: Perform, in the first scene of the first turn if it is predetermined in the virtual game that a target operation is performed on at least one virtual object in the combat area, the target operation on the at least one virtual object in the combat area, the at least one virtual object being controlled by a player account. The performing the target operation on the at least one virtual object in the combat area may be predetermined in a game program of a terminal.

In some embodiments, an example in which the virtual game is a network game is used. The method for controlling a virtual object may be cooperatively implemented by the terminal device 102 and the server 106. Specifically, the terminal device 102 is configured to: display a combat area of a currently running virtual game, the virtual game being a TBG; display a first scene identifier when a first turn of the virtual game is entered, the first scene identifier being configured for indicating a first scene where the first turn is situated; and transmit data in the virtual game to the server 106 in the first scene of the first turn. The server 106 is configured to predetermine that a target operation is performed on at least one virtual object in a combat area, and transmit an operation instruction to the terminal device 102. The terminal device 102 is configured to receive the operation instruction, and control the at least one virtual object in the combat area to perform the target operation based on the operation instruction.

Through the foregoing manner, when the first turn of the virtual game is entered, the target operation in the first scene is performed on the at least one virtual object controlled by the player account based on the first scene identifier displayed on the game interface. In other words, with reference to a scene where a current turn is situated, different types of target operations may be performed on the virtual object in different scenes, thereby increasing diversity of operation forms, and achieving a technical effect of improving flexibility of a manner for controlling the virtual object.

The solution collaboratively implemented by the terminal device and the server mainly involves two game modes, which are respectively a local game mode and a cloud game mode. The local game mode means that the terminal device and the server collaboratively run a game processing logic. Some of the operation instructions inputted by the player in the terminal device are processed by terminal device running game logic, and the other part is processed by server running game logic. In addition, the game processing logic run by the server is often more complex and requires more computing power. The cloud game mode means that the game processing logic is completely run by the server (for example, a cloud server), and the cloud server renders game scene data into an audio/video stream, and transmits the audio/video stream to the terminal device for display through a network. In other words, the terminal device only needs to have a basic streaming media playback capability and a capability of obtaining an operation instruction of the player and transmitting the operation instruction to the server.

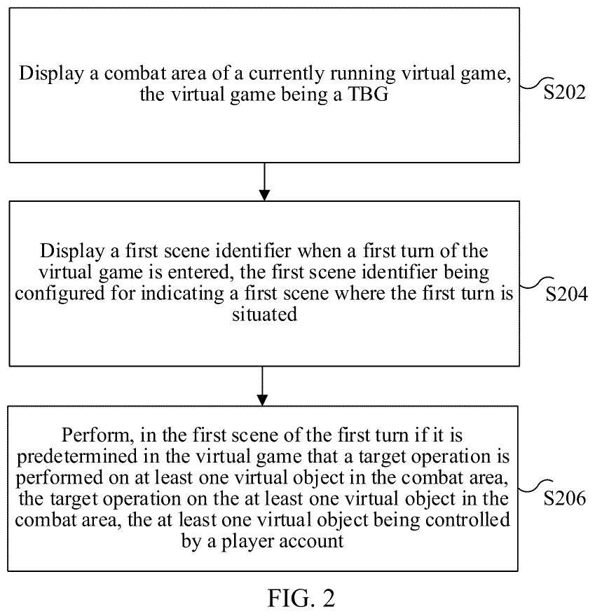

To solve the foregoing problem that the virtual object is controlled in a single form, a method for controlling a virtual object is provided in the embodiments of the present disclosure. FIG. 2 is a flowchart of a method for controlling a virtual object according to an embodiment of the present disclosure. The process includes the following operation S202 to operation S206.

Operation S202: Display a combat area of a currently running virtual game, the virtual game being a TBG.

In some embodiments, the virtual game includes a combat area and a preparation area. A plurality of virtual objects configured for combating held by a current account are placed in the combat area. A virtual object in the combat area is configured to battle with a virtual object in a combat area of an opponent account. A virtual object that is to be selected to be transferred to the combat area held by the current account is placed in the preparation area.

Operation S204: Display a first scene identifier when a first turn of the virtual game is entered, the first scene identifier being configured for indicating a first scene where the first turn is situated.

Operation S206: Perform, in the first scene of the first turn if it is predetermined in the virtual game that a target operation is performed on at least one virtual object in the combat area, the target operation on the at least one virtual object in the combat area, the at least one virtual object being controlled by a player account.

For ease of understanding, in this embodiment of the present disclosure, the foregoing method for controlling a virtual object is described by using an auto chess game as an example.

The auto chess game is a game mode of placing a piece for a battle. A player battles against another party by using the piece to combat to obtain upgrade.

In some embodiments, if the virtual game is a local game, performing of the target operation on the at least one virtual object in the combat area may be predetermined in a game program of a terminal device. If the virtual game is an online game, performing of the target operation on the at least one virtual object in the combat area may be predetermined in a backend server.

A game system may be but is not limited to a server (for example, may be the foregoing server 106) configured to perform the foregoing virtual game, and a backend service program of a game runs in the server.

In this embodiment of the present disclosure, in addition to buff effects of applying an additional fixing mechanism (for example, one slaying may lose a hit point of a virtual character to 10) to a piece, a piece fetter, or a board grid is put into effect in the related art, a special mechanism outside a board is further proposed, and is applied to an entire game section. The special mechanism is respectively described below with reference to different embodiments.

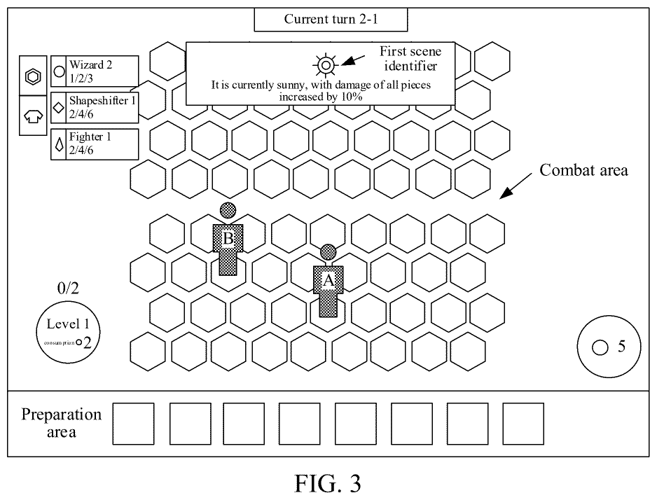

As shown in FIG. 3, it is assumed that the weather gameplay is used as an example. In a first turn of a combat stage after the game starts, the first scene identifier, for example, a sunny, is displayed on a game interface. In the first turn, if a slaying operation is performed on a virtual object A (which may alternatively be understood as a piece A), a damage index of the virtual object A is increased by 10% compared with a normal damage index, for example, the hit point is reduced by 100 in a normal case. In the first turn, the piece A is slaying, so that the hit point of the piece A is reduced by 110.

Apparently, the first scene identifier “sunny” shown in FIG. 3 is merely an example, and is not limited thereto. For example, 2 first scene identifiers may be displayed on the game interface of the first turn, or 2 different types of scene identifiers may be displayed on the game interface of the first turn. For different types of first scene identifiers, a corresponding target operation may be performed on the at least one virtual object in the combat area in the first turn.

In some embodiments, the first scene identifier may include, but is not limited to, at least one of the following:
the first scene identifier is a virtual weather identifier, and the first scene is a virtual weather represented by the first scene identifier; or
the first scene identifier is a virtual date identifier, and the first scene is a virtual date represented by the first scene identifier; or
the first scene identifier is a virtual subject identifier, and the first scene is a virtual subject represented by the first scene identifier.

The virtual weather identifier includes, but is not limited to, at least one of the following: sunny, thunderstorm, frost, and typhoon. The virtual subject identifier may include, but is not limited to, at least one of the following: party, family, vacation. The virtual date identifier may be, but is not limited to, a holiday or a month. The foregoing different types of scene identifiers are respectively described below with reference to specific embodiments.

Through the foregoing manner, when the first turn of the virtual game is entered, the target operation in the first scene is performed on the at least one virtual object controlled by the player account based on the first scene identifier displayed on the game interface. In other words, with reference to a scene where a current turn is situated, different types of target operations may be performed on the virtual object in different scenes, thereby increasing diversity of operation forms, and achieving a technical effect of improving flexibility of a manner for controlling the virtual object.

In some embodiments, the performing a target operation on the at least one virtual object in the combat area in the first turn includes:
performing, in the first turn, an attribute adjustment operation on the at least one virtual object in the combat area, the attribute adjustment operation including at least one of the following: adjusting an object attribute of the at least one virtual object in the first turn, adjusting a skill attribute of the at least one virtual object in the first turn, and adjusting an item attribute of the at least one virtual object in the first turn.

The foregoing attribute adjustment operation may be, but is not limited to, adjusting an attribute or an attribute value corresponding to the combat stage of the first turn through the game system. The attribute or the attribute value corresponding to the combat stage of the first turn includes damage, a defense value, or the like caused by performing an attack operation or performing a defense operation.

In some embodiments, the attribute adjustment operation is performed based on a set amplitude or value. For example, the set amplitude may be one percent, and the set value may be 100.

In some embodiments, the performing an attribute adjustment operation on the at least one virtual object in the combat area in the first turn includes at least one of the following:
adjusting, in the first turn, at least one of an attack value and a defense value of the at least one virtual object in the combat area, the object attribute including at least one of the attack value and the defense value, the attack value being configured for indicating damage caused when the at least one virtual object performs a virtual attack operation in the first turn, and the defense value being configured for indicating damage caused to the at least one virtual object when the at least one virtual object is subjected to the virtual attack operation in the first turn;
adjusting, in the first turn, at least one of a quantity of skill release times and a skill cooling time of the at least one virtual object in the combat area, the skill attribute including at least one of the quantity of skill release times and the skill cooling time, the quantity of skill release times being configured for indicating a quantity of times the at least one virtual object is allowed to release a virtual skill in the first turn, and the skill cooling time being configured for indicating a waiting duration between a time when the at least one virtual object releases the virtual skill in the first turn and a time when the virtual skill is allowed to be released next time; and
adjusting, in the first turn, at least one of an item attack value and an item defense value of a virtual item used by the at least one virtual object in the combat area, the item attribute including at least one of the item attack value and the item defense value, the item attack value being configured for indicating damage caused by the at least one virtual object performing the virtual attack operation through the virtual item in the first turn, and the item defense value being configured for indicating damage caused to the at least one virtual object when the at least one virtual object using the virtual item is subjected to the virtual attack operation in the first turn.

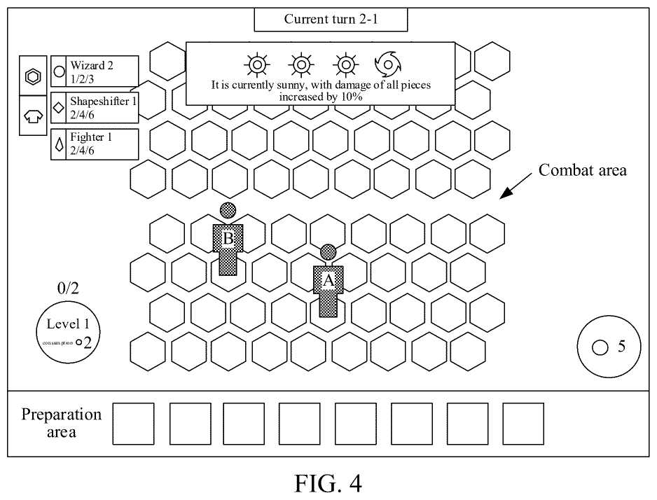

As shown in FIG. 4, it is assumed that the weather gameplay is still used as an example. After the game starts, weather identifiers in current 3 turns and a weather identifier in a next stage are displayed at a preparation stage after a first combat section. For example, weather of the competition in the current 3 turns is sunny, and the weather of the competition is switched to typhoon weather after the three turns.

The weather identifier in the next stage may be, but is not limited to, a next turn after 3 turns, or a next stage of a current stage of one of the 3 turns. For example, one turn includes two combat stages before and after each other, and the current stage is a stage before the first turn, and then the stage after the first turn is the next stage.

When the first scene identifier is sunny, at least one of the attack value and the defense value of the at least one virtual object in the combat area is adjusted in the first turn. For example, if a virtual attack operation is performed on a virtual object A in the first turn, damage caused by the virtual attack operation is increased by 10% compared with a normal damage value. Alternatively, in the first turn, if the virtual attack operation is performed on a virtual object B, damage caused to the virtual object B increases by 10% when the virtual object B is subjected to the virtual operation, or the like.

In some embodiments, for example, it is assumed that when the first scene identifier is snowing, at least one of a quantity of skill release times and a skill cooling time of at least one piece in the combat area is adjusted in the first turn. The skill cooling time refers to a time interval that needs to be waited for between any two consecutive release operations when the same skill is continuously released. In other words, after a skill is released, the skill may be released again by waiting for the skill cooling time, and the skill cannot be released within the skill cooling time. For example, assuming that in non-snowing weather, the quantity of skill release times of each piece in the first turn is 5 and a time interval between two skill releases is 2 s, the quantity of skill release times of each piece in the first turn is reduced to 3, and the time interval between two skill releases is increased to 3 s when the first scene where the first turn is situated is a snowy weather.

In some embodiments, at least one of an item attack value and an item defense value of virtual item used by the at least one virtual object in the combat area is adjusted in the first turn. For example, it is assumed that when a game mode of the auto chess game is an entertainment gameplay, an influence range of the entertainment gameplay covers an item or a fetter. The fetter generally refers to a special mechanism in the game, and allows a player to obtain an additional advantage or effect by combining a particular game element (for example, a character, a unit, or a card), for example, upgrading a random item to a bright item (a stronger item type, for example, virtual item with an increased item attack value or item defense value) in the turn.

Through the foregoing manner, in different game modes, different types of scene identifiers can be combined, different operations can be performed on virtual objects in different areas of the game interface in the first turn, and an attribute value of the at least one virtual object in the different areas can be adjusted, thereby increasing diversity of control forms and improving game battle experience of a user.

In some embodiments, the displaying a first scene identifier when a first turn of the virtual game is entered includes:
displaying the first scene identifier and N scene identifiers when the first turn of the virtual game is entered, N being a positive integer, the N scene identifiers being configured for indicating a scene where each of consecutive N turns after the first turn is situated, if the N scene identifiers include an i^{th} scene identifier and a j^{th} scene identifier, the i^{th} scene identifier is configured for indicating an i^{th} scene where an i^{th} turn of the consecutive N turns is situated, the j^{th} scene identifier is configured for indicating a j^{th} scene where a j^{th} turn of the consecutive N turns is situated, and the i^{th} scene is different from the j^{th} scene, the virtual game being configured to perform an i^{th} operation on an i^{th} group of virtual objects controlled by the player account in the combat area when the scene where the i^{th} turn is situated is the i^{th} scene, and being configured to perform a j^{th} operation on a j^{th} group of virtual objects controlled by the player account in the combat area when the scene where the j^{th} turn is situated is the j^{th} scene, i and j being both positive integers less than or equal to N, and i being different from j; and
virtual objects in the i^{th} group of virtual objects being at least partially different from virtual objects in the j^{th} group of virtual objects, and the i^{th} operation being different from the j^{th} operation; or the virtual objects in the i^{th} group of virtual objects being at least partially different from the virtual objects in the i^{th} group of virtual objects, and the i^{th} operation being the same as the j^{th} operation; or the virtual objects in the i^{th} group of virtual objects being the same as the virtual objects in the j^{th} group of virtual objects, and the i^{th} operation being different from the j^{th} operation.

In some embodiments, when the N scene identifiers include two different scene identifiers and the two different scene identifiers are configured for indicating two different scenes, the game system is configured to perform different operations on the same virtual object or different virtual objects controlled by the player account in the combat area when scenes in which two different turns in the N consecutive turns are respectively two different scenes, or perform the same operation on different virtual objects controlled by the player account in the combat area.

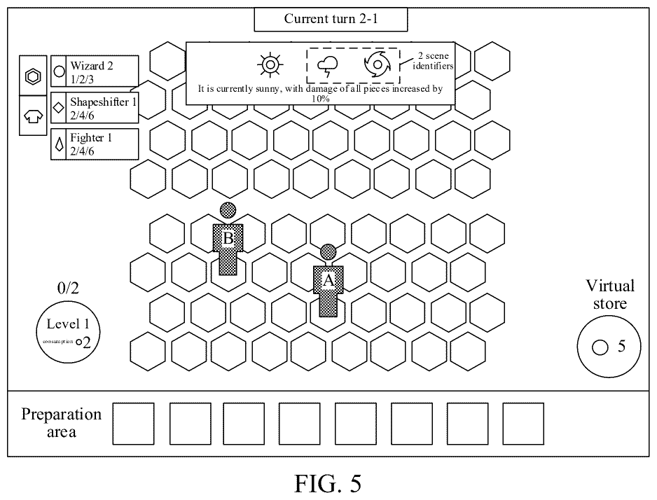

In an embodiment shown in FIG. 5, it is assumed that when the first turn of the virtual game is entered, a first scene identifier “sunny” and N=2 scene identifiers are displayed on the game interface. The 2 scene identifiers are respectively thunderstorm and typhoon. The thunderstorm identifies a scene where a 1^{st} turn is situated after the first turn, and the typhoon identifier represents a scene where a 2^{nd} turn is situated after the first turn.

It may be determined, based on the thunderstorm identifier, that a first operation is performed on a first group of virtual objects (a first group of pieces) controlled by a player account in a combat area in the 1^{st} turn after the first turn. It may be determined, based on the typhoon identifier, that a second operation is performed on a second group of virtual objects (a second group of pieces) controlled by the player account in the combat area in the 2^{nd} turn after the first turn. The first operation may be, but is not limited to, that the pieces on a game field are randomly struck by lightning, and the struck pieces are stunned. The second operation may be, but is not limited to, prohibiting use and purchase of a piece (a virtual object) in a virtual store in a virtual scene.

Apparently, the N=2 scene identifiers shown in FIG. 5 are merely an example and are not limited thereto. For example, there may also be N=3 scene identifiers, and the 2 or 3 scene identifiers may be the same or may be different.

It may be learned that the target operation allowed to be performed on the virtual object in the combat area is different in different scene identifiers. In addition, the different target operations affect different virtual objects. Therefore, variability in a game battle process is increased, and game experience is improved. The scene identifier provides intuitive visual feedback, helping the player quickly recognize and respond to a change of a game environment. The player may plan a policy in advance based on the displayed scene identifier, for example, use different virtual object combinations or skills in different scenes.

In some embodiments, the displaying a first scene identifier when a first turn of the virtual game is entered includes: displaying the first scene identifier and N scene identifiers when the first turn of the virtual game is entered, N being a positive integer, and the N scene identifiers being configured for indicating a scene where each of consecutive N turns after the first turn is situated.

The foregoing method further includes: prohibiting, when a k^{th} scene identifier in the N scene identifiers is configured for indicating a k^{th} scene where a k^{th} turn of the consecutive N turns is situated, and if it is predetermined in the virtual game that the player account is prohibited from obtaining the virtual object or selling the virtual object from or to a virtual store, the player account from obtaining the virtual object or selling the virtual object from or to the virtual store in the k^{th} turn, k being a positive integer less than or equal to N; or
prohibiting, when an r^{th} scene identifier in the N scene identifiers is configured for indicating an r^{th} scene where an r^{th} turn of the consecutive N turns is situated, and if it is predetermined in the virtual game that the player account is prohibited from upgrading or synthesizing at least one virtual object in the combat area or a preparation area of the virtual game, the player account from upgrading or synthesizing the at least one virtual object in the combat area or the preparation area of the virtual game in the r^{th} turn or in R turns, r being a positive integer less than or equal to N, the R turns including a plurality of consecutive turns starting from the r^{th} turn, and R being a positive integer greater than or equal to 2.

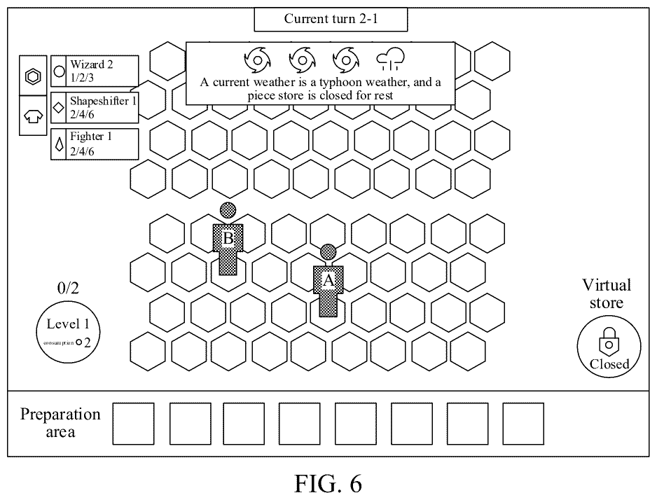

As shown in FIG. 6, assuming that N=4 scene identifiers include 3 typhoon identifiers and 1 thunderstorm identifier, the virtual store displays a locking style (closed) when a typhoon weather corresponding to a (k=1)^{th} scene identifier (the typhoon) in the 4 scene identifiers is entered. In other words, the player account cannot obtain the virtual object from the virtual store or cannot sell the virtual object.

Therefore, in a case of entering the first turn, the player may prepare for the first turn in advance based on predicted N=4 scene identifiers. For example, because a piece (a virtual object) cannot be purchased in 3 turns indicated by first 3 scene identifiers (typhoon) in the N=4 scene identifiers, the player purchases the piece in advance in the first turn.

A manner of prohibiting the player account from obtaining the virtual object or selling the virtual object in the virtual store includes, but is not limited to, the following two manners.

In a first manner, as shown in FIG. 6, a display style of the virtual store is a locked state, and a list of virtual objects in the store cannot be entered by performing a trigger operation on a virtual store identifier.

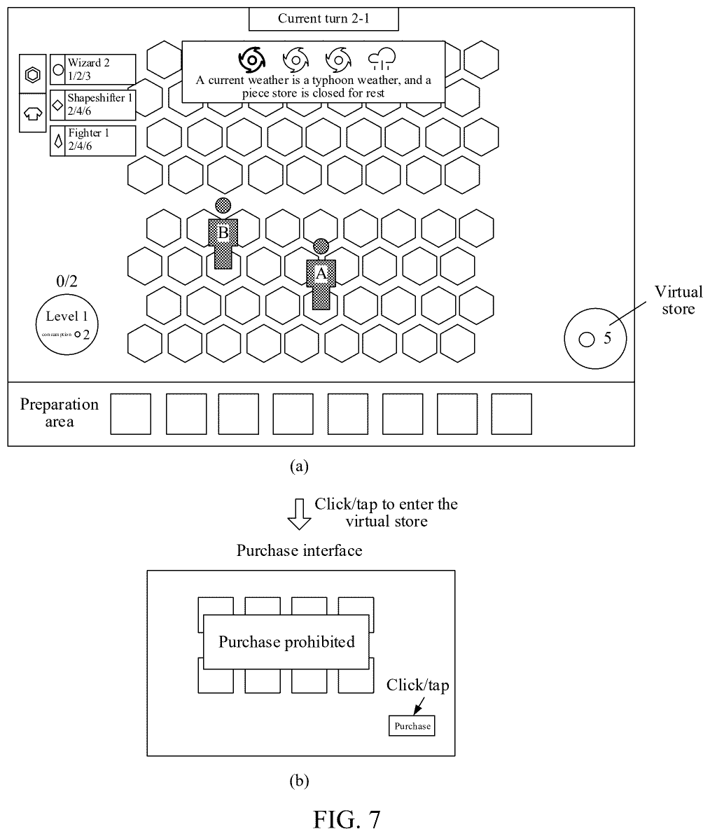

In a second manner, as shown in (a) of FIG. 7, a display style of the virtual store is not changed, and after the trigger operation is performed, a purchase interface of the virtual object may be entered, but after a “Purchase” button is clicked/tapped, a “Purchase prohibition” window shown in (b) of FIG. 7 pops up. Alternatively, after the “Purchase” button is clicked/tapped, no response exists in the purchase interface.

In some embodiments, a weather effect in the foregoing scene identifier is not limited to the combat area, and may also have impact on the preparation area.

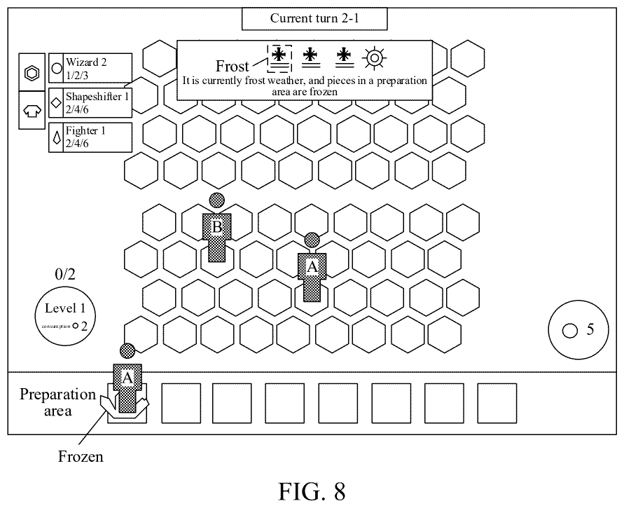

For example, as shown in FIG. 8, assuming that the r^{th} scene identifier is a frost weather, a piece A in a current preparation area is frozen for 3 turns, for example, star rising synthesizing, going to the field, and the like cannot be performed.

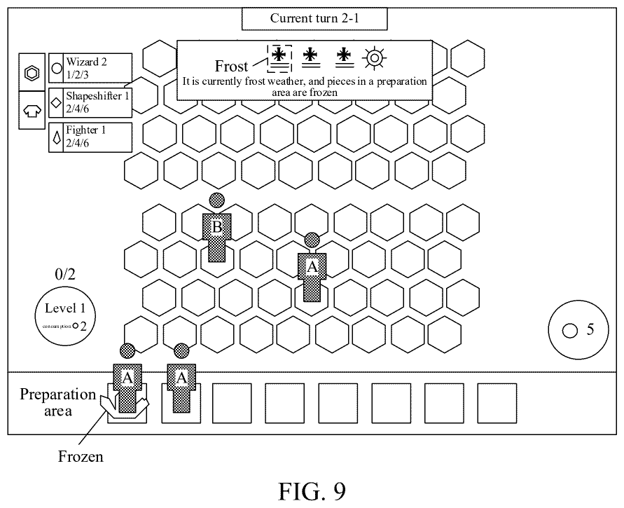

For another example, as shown in FIG. 9, a piece A in the preparation area is frozen, the player purchases another piece A in the r^{th} turn, and originally a total of 3 pieces A that can be synthesized into 2 stars exist, but the piece A cannot be synthesized because of the freezing.

In addition, the prohibiting at least one virtual object in a preparation area of a virtual game from being upgraded further includes prohibiting a preset quantity of virtual objects from being upgraded from an original character to a higher level. For example, because 1 piece A is frozen, 2 pieces A originally owned may be upgraded from a primary master to an intermediate master. However, because one chess piece A is frozen, normal upgrading cannot be performed.

In the foregoing manner, due to an influence of a scene where a current turn is situated, an effect range of performing a target operation on at least one virtual object in the virtual game may be expanded to a combat area, a preparation area, and the like in a virtual scene, thereby improving interest of a game gameplay. A game provides a plurality of different challenges and policy paths through different scene identifiers and corresponding restriction measures, thereby increasing diversity of the game. A dynamic change of the virtual game is achieved by implementing different restrictions in different scenes, thereby increasing diversity and challenge of the virtual game.

In some embodiments, the displaying a first scene identifier when a first turn of the virtual game is entered includes: displaying the first scene identifier and N scene identifiers when the first turn of the virtual game is entered, N being a positive integer, and the N scene identifiers being configured for indicating a scene where each of consecutive N turns after the first turn is situated.

The foregoing method further includes: displaying M scene identifiers when a last turn of the consecutive N turns is ended and a next turn of the last turn is entered, M being a positive integer, the M scene identifiers being configured for indicating a scene where each of the consecutive M turns after the last turn is situated, scene identifiers in the M scene identifiers being at least partially different from scene identifiers in N+1 scene identifiers, and the N+1 scene identifiers including the first scene identifier and the N scene identifiers.

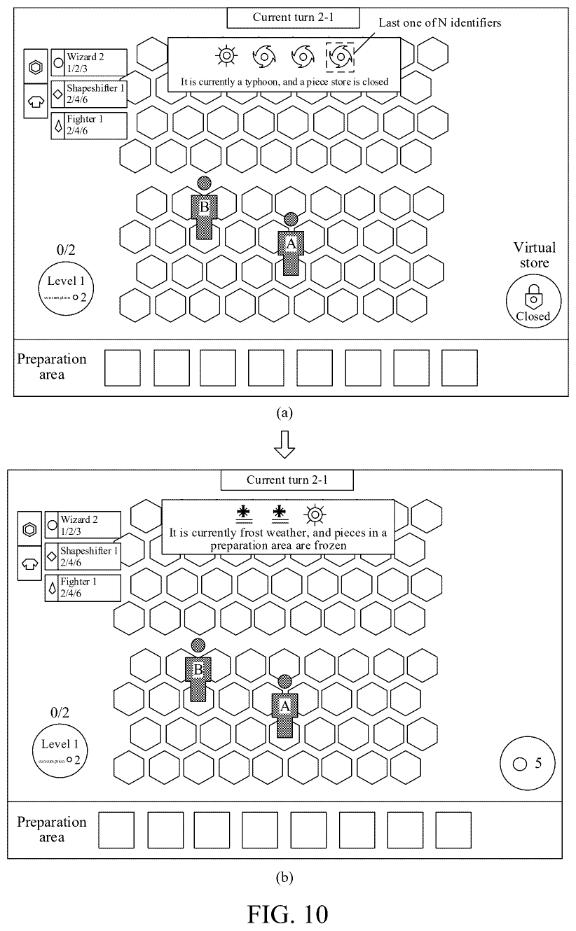

As shown in (a) of FIG. 10, assuming that the first scene identifier is sunny and N=3 scene identifiers are all typhoon, when the last turn in the 3 turns corresponding to the 3 typhoon identifiers is ended and a next turn of the last turn is entered, M=3 scene identifiers shown in (b) of FIG. 10 are randomly displayed on the game interface. The 3 scene identifiers are respectively 2 frosts and 1 typhoon.

It may be learned that the M=3 scene identifiers and the first turn and N=3 scene identifiers have the same typhoon identifier, and have a frost identifier different from those in the first turn and the N=3 scene identifiers.

In some embodiments, an implementation process of randomly displaying M scene identifiers includes the following:
the displaying the first scene identifier and N scene identifiers when the first turn of the virtual game is entered includes: randomly selecting a first predetermined quantity of scene identifiers from a preset scene identifier set when the first turn of the virtual game is entered, to obtain the first scene identifier and the N scene identifiers, and displaying the first scene identifier and the N scene identifiers, the first predetermined quantity being equal to N+1; and
the displaying M scene identifiers when a last turn of the consecutive N turns is ended and a next turn of the last turn is entered includes: randomly selecting a second predetermined quantity of scene identifiers from the scene identifier set when the last turn of the consecutive N turns is ended and the next turn of the last turn is entered, to obtain the M scene identifiers, and displaying the M scene identifiers, the second predetermined quantity being equal to M.

The foregoing M scene identifiers are scene identifiers randomly allocated by the game system when the last turn in the N turns ends, so that the entire game is linearly and randomly changed, and a changeable additional mechanism is enriched, thereby making an originally repetitive and tedious battle more strategic, and enriching game experience of the player.

In addition, in addition to displaying a scene identifier of a current turn on the game interface, a scene identifier of a next section stage is further displayed, so that the player can perform determining on a game mechanism effect of the next stage in advance, for example, going right to a shopping day turn (a price of a piece in the shopping day turn is halved), and may consider reducing economic investment, and purchasing a plurality of pieces at a time in the shopping day turn, thereby quickly improving overall fighting strength. For another example, if the virtual store is closed in a typhoon weather turn, before the typhoon weather, gold coins may be selected to be consumed to strengthen lineup, reduce fault tolerance, and the like.

In some embodiments, the performing a target operation on the at least one virtual object in the combat area in the first turn includes:
performing, in the first turn, an attack operation on the at least one virtual object in the combat area, the target operation including the attack operation.

In some embodiments, the performing an attack operation on the at least one virtual object in the combat area includes at least one of the following:
performing the attack operation on the at least one virtual object in the combat area at certain moments in the first turn;
performing the attack operation on the at least one virtual object situated in certain positions in the combat area in the first turn; and
performing the attack operation on the at least one virtual object situated in certain positions in the combat area at certain moments in the first turn.

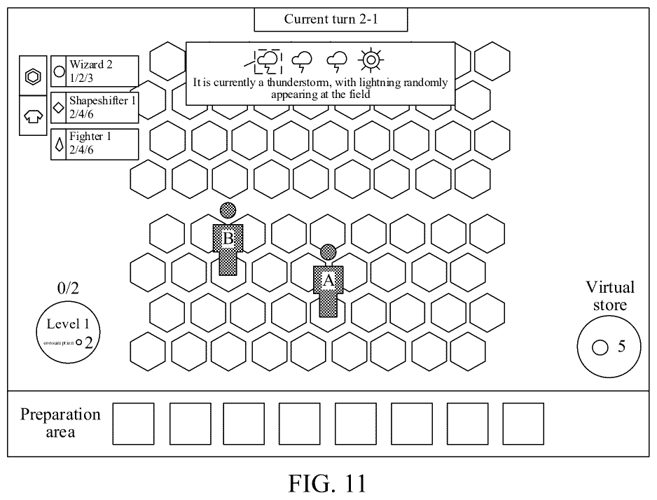

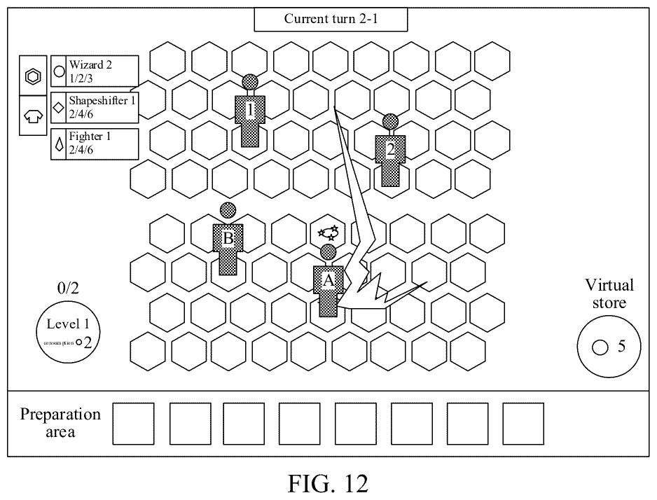

The weather effect in the foregoing scene identifier is not limited to a virtual store, a buff type, and the like, and may also be reflected in environment interaction. For example, as shown in FIG. 11, after a thunderstorm weather is entered, a lightning is randomly generated in a virtual scene, and at least one piece (a virtual object) in a combat area is randomly struck. For example, as shown in FIG. 12, a piece A in a combat area is randomly struck, and the struck piece A is stunned within a preset duration, so that no skill can be released within the preset duration.

Alternatively, after the thunderstorm weather is entered, the lightning is generated, and pieces (virtual objects) on at least some areas of the combat area are randomly struck, for example, pieces on a middle position of the combat area are randomly struck, or pieces on all positions of the combat area are randomly struck.

Alternatively, after the thunderstorm weather is entered, the lightning is generated at a random moment (which may be 1 moment, or may be a plurality of moments), and at least one virtual object at partial position in the combat area is randomly struck.

In some embodiments, the foregoing certain moments are moments randomly determined in the first turn, and the foregoing certain positions are positions randomly determined in the combat area.

Through the foregoing random selection of different gameplay modes, game fatigue brought by long-line repeated battles is reduced, and a periodical special mechanism is added, so that battle strategy of the player is greatly enhanced.

In some embodiments, the foregoing method further includes:
prohibiting, in the first scene of the first turn, the player account from obtaining the virtual object from the virtual store or selling the virtual object if it is predetermined in the virtual game that the player account is prohibited from obtaining the virtual object from the virtual store or selling the virtual object; or
predetermining, in the first scene of the first turn, that the player account is prohibited from upgrading or synthesizing the at least one virtual object in the combat area or the preparation area of the virtual game in the virtual game, and prohibiting, in the first turn or in P turns, the player account from upgrading or synthesizing the at least one virtual object in the combat area or the preparation area of the virtual game, the P turns including a plurality of consecutive turns starting from the first turn, and P being a positive integer greater than or equal to 2.

For a specific implementation process of prohibiting the player account from obtaining the virtual object or selling the virtual object in the virtual store in the first turn, reference may be made to descriptions about FIG. 6 and FIG. 7 in the foregoing embodiment. Details are not described herein again.

For an implementation of prohibiting the player account from upgrading or synthesizing the at least one virtual object in the combat area or the preparation area of the virtual game in the first turn or in the P turns, reference may be made to FIG. 8 and FIG. 9.

For example, the effect of the weather gameplay is not limited to the combat area, but may also affect the preparation area. For example, in a frost weather, a piece in a current preparation area is frozen for a current turn or a plurality of turns, and star rising synthesizing, going to the field, and the like cannot be performed. As shown in FIG. 9, the piece A in the preparation area is frozen, the player purchases another piece A in a turn, and originally a total of 3 pieces A that can be synthesized into 2 stars exist, but the piece A cannot be synthesized because of the freezing.

In other words, the target operation performed on the virtual object in the current turn can not only act on at least one virtual object in the current turn, but also continuously act on a plurality of consecutive turns after the current turn, thereby further increasing a combination manner of a game mechanism, improving diversity of game changes, and helping the player to continuously perfect an obtained virtual object combination in the same mechanism. Through use of the same limitation for the preparation area, the player needs to manage the preparation area more effectively, to deal with possible upgrade and synthesis limitations, thereby increasing management and strategy of the game.

In some embodiments, the performing a target operation on the at least one virtual object in the combat area in the first turn includes:
adding, when each of the at least one virtual object in the combat area has attributes of a combination type and effective quantities corresponding to the attributes of the combination type possessed by each virtual object, the effective quantities corresponding to the attributes of the combination type possessed by each of the at least one virtual object, to obtain a total effective quantity, and modifying the effective quantity corresponding to the attribute of the combination type possessed by one of the at least one virtual object to the total effective quantity; and
setting, when the effective quantity corresponding to the attribute of the combination type possessed by a p^{th} virtual object of the at least one virtual object is a p^{th} quantity, the attribute of the combination type possessed by the p^{th} virtual object to trigger release of a target skill or trigger adjustment of an attack value of the p^{th} virtual object when a quantity of virtual objects with a target type in the combat area is greater than or equal to the p^{th} quantity, the attack value being configured for indicating damage caused by the p^{th} virtual object performing the virtual attack operation, or trigger adjustment of a defense value of the p^{th} virtual object, the defense value being configured for indicating damage caused to the p^{th} virtual object when the p^{th} virtual object is subjected to the virtual attack operation, and p being a positive integer.

The attribute of a combination type may be understood, but is not limited to, as a fetter. In an auto chess game, the fetter may be understood, but is not limited to, as that a combination effect may be generated for a plurality of pieces based on an occupation and a race. For example, when 3 different masters simultaneously present, a magic resistance capability of enemies may be reduced. In other words, some specially combined pieces may be set together to generate some additional effects.

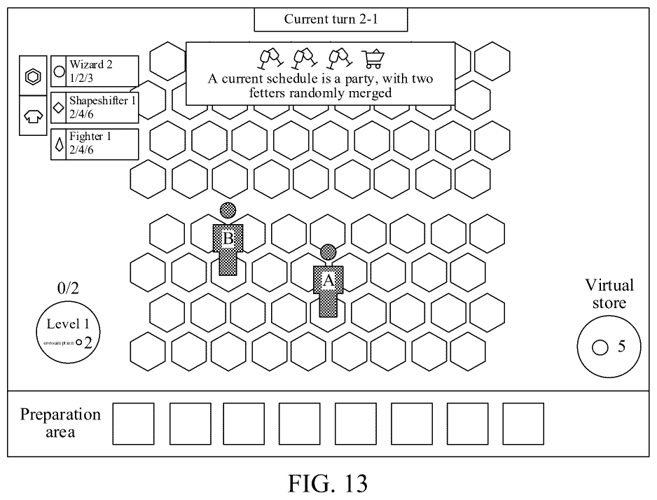

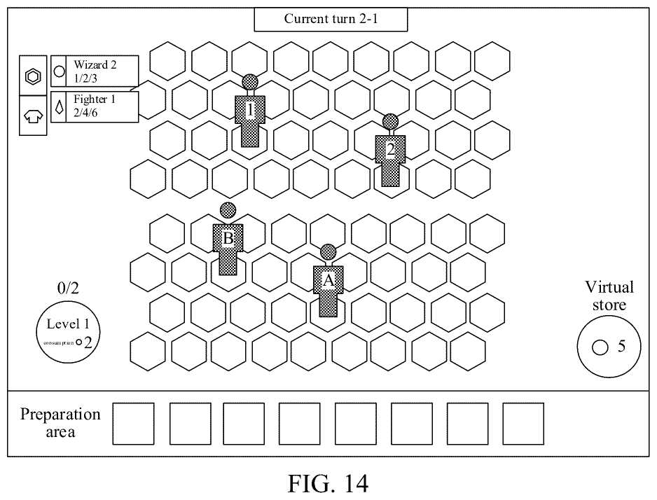

In some embodiments, for example, in a party turn as shown in FIG. 13, 2 fetters are randomly merged, and 1 fetter is selected to take effect, and an effective quantity is the sum of the 2 fetters. As shown in FIG. 13, a wizard fetter is merged with a shapeshifter fetter, and the wizard fetter is selected to take effect, and the quantity of the wizard fetters activated is changed from original 2 to 3, which is the sum of two fetters (the quantity of the wizard fetters activated is 2 and the shapeshifter fetters activated is 1) as shown in FIG. 14.

In addition, the foregoing attribute of a combination type may also be a fighter fetter another fetter, or the like. When the foregoing effective quantity corresponding to at least 2 fetters is a p^{th} quantity, the attribute of a combination type possessed by the p^{th} virtual object is set to trigger adjustment of an attack value or a defense value of the p^{th} virtual object, specifically, adjustment of damage caused by the virtual attack operation performed by the p^{th} virtual object or adjustment of damage caused to the p^{th} virtual object when the p^{th} virtual object is subjected to the virtual attack operation when the quantity of the virtual objects with a target type in the combat area is greater than or equal to the p^{th} quantity.

In the foregoing manner, through introducing the scene identifier, in addition to acting on at least one virtual object in different areas in a virtual game, the scene identifier may further act on different contents in a virtual game scene, for example, affecting a virtual object and an item in the preparation area, and piece fetter in the game, thereby avoiding a defect of a fixed game gameplay in the related art that a combat section becomes tedious and lacks variability between turns, improving diversity of an overall strategy of the game, and enriching player experience.

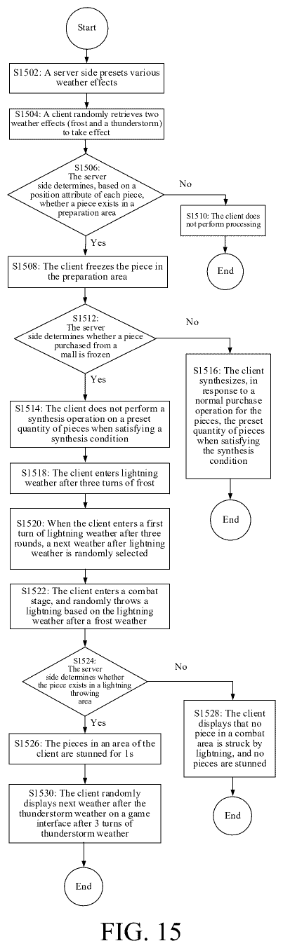

To understand the technical solutions in the foregoing embodiments more clearly, the foregoing method for controlling a virtual object is further described below with reference to an overall flowchart shown in FIG. 15.

Specifically, the operations are shown below.

S1502: A server side (which may be, for example, the server 106 in FIG. 1) presets various weather effects.

The server side sets various gameplay modes, for example, a weather gameplay mode and a daily life gameplay mode.

S1504: A client (which may be, for example, the terminal device 102 in FIG. 1) randomly retrieves two weather effects to take effect.

For example, two weather effects, frost and thunderstorm, are randomly selected to take effect, and a current turn is frost. Then, operation S1506 is performed.

S1506: The server side determines, based on a position attribute of each piece, whether a piece exists in a preparation area in a virtual game scene.

In some embodiments, the position attribute of each piece is obtained, a position of the piece in a virtual game is determined based on the position attribute, and whether the position of the piece is in the preparation area is determined. In other words, whether the piece exists in the preparation area is determined. If yes, an operation instruction is transmitted to the client, so that the client performs operation S1508 based on the operation instruction. Otherwise, the operation instruction is not transmitted to the client, so as to instruct the client to perform operation S1510.

S1508: The client freezes the piece in the preparation area.

The frozen piece cannot be synthesized or put to the field, and the frozen piece is recorded.

S1510: The client does not perform processing.

In some embodiments, the pieces in the preparation area are kept in an original state, and a piece in a frozen state does not exist.

S1512: The server side determines whether a piece purchased from a mall is frozen.

In some embodiments, it is determined whether the piece purchased in the virtual mall is the frozen piece based on the recorded frozen piece. If yes, the operation instruction transmitted to the client, so that the client performs operation S1514 based on the operation instruction. Otherwise, the operation instruction is not transmitted to the client, so as to instruct the client to perform operation S1516.

S1514: The client does not perform a synthesis operation on a preset quantity of pieces when satisfying a synthesis condition.

In some embodiments, the satisfying a synthesis condition characterizes that a quantity of pieces is equal to the preset quantity.

Exemplarily, if the preset quantity is 3, for chess pieces in a non-frozen state, if the quantity of the pieces in the non-frozen state is equal to 3, the synthesis operation is performed on the 3 pieces in the non-frozen state. If at least one piece is in the frozen state, even if the quantity of the pieces reaches 3, synthesizing is not performed.

S1516: The client synthesizes, in response to a normal purchase operation for the pieces, the preset quantity of pieces when satisfying the synthesis condition.

Exemplarily, if the preset quantity is 3 and a current quantity of the pieces is 1, in response to the purchase operation on the pieces, the synthesis operation is performed on the 3 pieces if the quantity of the pieces is 3.

S1518: The client enters lightning weather after three turns of frost.

S1520: When the client enters a first turn of lightning weather after three rounds (the frost), a next weather after lightning weather is randomly selected

For example, the next weather after the lightning weather is randomly selected as a sunny, so as to remind the player to perform an attack operation, because the damage of all pieces increases by 10% on sunny.

In some embodiments, when the virtual game is a local game, a game program of the client randomly selects the next weather after the lightning weather. If the virtual game is an online game, the client transmits current game data to the server side, the server side transmits the operation instruction randomly selected to the client, and after receiving the operation instruction randomly selected, the client randomly selects the next weather after the lightning weather.

S1522: The client enters a combat stage, and randomly throws a lightning based on the lightning weather after a frost weather.

The randomly throwing a lightning includes, but is not limited to, throwing a lightning on at least one piece in the combat area at a random moment, randomly throwing a lightning on at least one piece in at least partial areas of the combat area, and the like.

S1524: The server side determines whether the piece exists in a lightning throwing area.

The operation instruction is transmitted to the client if the piece exists, so that the client performs operation S1526 based on the operation instruction. Otherwise, the operation instruction is not transmitted to the client, so as to instruct the client to perform operation S1528.

The lightning throwing area includes, but is not limited to, any area or some areas in an entire combat area.

S1526: The pieces in an area of the client are stunned for 1 s.

1 s stun characterizes that no operation can be performed on the piece within 1 s. In other words, the piece is in a state in which the piece cannot be processed within 1 s. The stunning duration is merely an example, and is not limited, for example, may further be 2 s or 3 s.

S1528: The client displays that no piece in a combat area is struck by lightning and no piece is stunned.

S1530: The client randomly displays next weather after a thunderstorm weather on a game interface after 3 turns of thunderstorm weather.

For example, a sunny identifier is displayed, and different target operations are performed on different virtual objects in a corresponding sunny turn.

According to this embodiment of the present disclosure, it may be learned that different types of operations may be performed on another content such as different areas and different items in the virtual game scene based on the randomly displayed scene identifier, thereby enriching diversity of game gameplay and improving variability of the battle of the player.

For brevity, the foregoing method embodiments are described as a series of action combinations. However, it is to be appreciated by a person skilled in the art that the present disclosure is not limited to the described sequence of the actions, because some operations may be performed in another sequence or simultaneously according to the present disclosure. In addition, a person skilled in the art is further to understand that the embodiments in the description are exemplary embodiments, and the involved actions and modules mentioned are not necessarily required by the present disclosure.

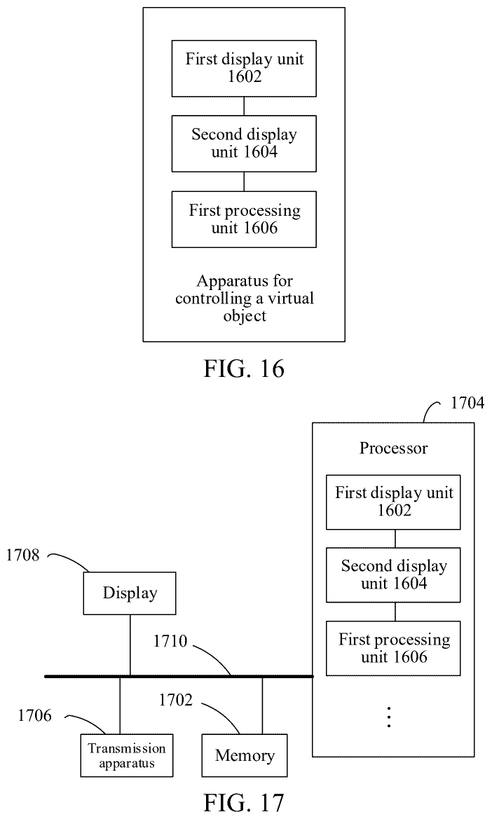

According to yet another aspect of the embodiments of the present disclosure, an apparatus for controlling a virtual object as shown in FIG. 16 is further provided. The apparatus includes:
a first display unit 1602, configured to display a combat area of a currently running virtual game, the virtual game being a TBG;
a second display unit 1604, configured to display a first scene identifier when a first turn of the virtual game is entered, the first scene identifier being configured for indicating a first scene where the first turn is situated; and
a first processing unit 1606, configured to perform a target operation on the at least one virtual object in the combat area in the first turn when a game system of the virtual game is set to perform the target operation on at least one virtual object controlled by a player account in the combat area when the scene in the first turn is the first scene.

In some embodiments, the foregoing first processing unit 1606 includes:
a first processing module, configured to perform, in the first turn, an attribute adjustment operation on the at least one virtual object in the combat area, the attribute adjustment operation including at least one of the following: adjusting an object attribute of the at least one virtual object in the first turn, adjusting a skill attribute of the at least one virtual object in the first turn, and adjusting an item attribute of the at least one virtual object in the first turn.

In some embodiments, the foregoing first processing module includes:
a first processing submodule, configured to perform at least one of the following:
adjusting, in the first turn, at least one of an attack value and a defense value of the at least one virtual object in the combat area, the object attribute including at least one of the attack value and the defense value, the attack value being configured for indicating damage caused when the at least one virtual object performs a virtual attack operation in the first turn, and the defense value being configured for indicating damage caused to the at least one virtual object when the at least one virtual object is subjected to the virtual attack operation in the first turn;
adjusting, in the first turn, at least one of a quantity of skill release times and a skill cooling time of the at least one virtual object in the combat area, the skill attribute including at least one of the quantity of skill release times and the skill cooling time, the quantity of skill release times being configured for indicating a quantity of times the at least one virtual object is allowed to release a virtual skill in the first turn, and the skill cooling time being configured for indicating a waiting duration between a time when the at least one virtual object releases the virtual skill in the first turn and a time when the virtual skill is allowed to be released next time; and
adjusting, in the first turn, at least one of an item attack value and an item defense value of a virtual item used by the at least one virtual object in the combat area, the item attribute including at least one of the item attack value and the item defense value, the item attack value being configured for indicating damage caused by the at least one virtual object performing the virtual attack operation through the virtual item in the first turn, and the item defense value being configured for indicating damage caused to the at least one virtual object when the at least one virtual object using the virtual item is subjected to the virtual attack operation in the first turn.

In some embodiments, the foregoing first display unit 1602 includes:
a first display module, configured to display the first scene identifier and N scene identifiers when the first turn of the virtual game is entered, N being a positive integer, the N scene identifiers being configured for indicating a scene where each of consecutive N turns after the first turn is situated, if the N scene identifiers include an i^{th} scene identifier and a j^{th} scene identifier, the i^{th} scene identifier is configured for indicating an i^{th} scene where an i^{th} turn of the consecutive N turns is situated, the j^{th} scene identifier is configured for indicating a j^{th} scene where a j^{th} turn of the consecutive N turns is situated, and the i^{th} scene is different from the j^{th} scene, the virtual game being configured to perform an i^{th} operation on an i^{th} group of virtual objects controlled by the player account in the combat area when the scene where the i^{th} turn is situated is the i^{th} scene, and being configured to perform a j^{th} operation on a j^{th} group of virtual objects controlled by the player account in the combat area when the scene where the j^{th} turn is situated is the j^{th} scene, i and j being both positive integers less than or equal to N, and i being different from j; and
virtual objects in the i^{th} group of virtual objects being at least partially different from virtual objects in the j^{th} group of virtual objects, and the i^{th} operation being different from the j^{th} operation; or the virtual objects in the i^{th} group of virtual objects being at least partially different from the virtual objects in the i^{th} group of virtual objects, and the i^{th} operation being the same as the j^{th} operation; or the virtual objects in the i^{th} group of virtual objects being the same as the virtual objects in the j^{th} group of virtual objects, and the i^{th} operation being different from the j^{th} operation.

In some embodiments, the foregoing first display unit 1602 includes:
a second display module, configured to display the first scene identifier and N scene identifiers when the first turn of the virtual game is entered, N being a positive integer, and the N scene identifiers being configured for indicating a scene where each of consecutive N turns after the first turn is situated.

The foregoing apparatus further includes:
a second processing unit, configured to prohibit, when a k^{th} scene identifier in the N scene identifiers is configured for indicating a k^{th} scene where a k^{th} turn of the consecutive N turns is situated, and if it is predetermined in the virtual game that the player account is prohibited from obtaining the virtual object or selling the virtual object from or to a virtual store, the player account from obtaining the virtual object or selling the virtual object from or to the virtual store in the k^{th} turn, k being a positive integer less than or equal to N; or
prohibit, when an r^{th} scene identifier in the N scene identifiers is configured for indicating an r^{th} scene where an r^{th} turn of the consecutive N turns is situated, and if it is predetermined in the virtual game that the player account is prohibited from upgrading or synthesizing at least one virtual object in the combat area or a preparation area of the virtual game, the player account from upgrading or synthesizing the at least one virtual object in the combat area or the preparation area of the virtual game in the r^{th} turn or in R turns, r being a positive integer less than or equal to N, the R turns including a plurality of consecutive turns starting from the r^{th} turn, and R being a positive integer greater than or equal to 2.

The foregoing apparatus further includes:
a second setting unit, configured to set a display style of the virtual store to a locked state, and cancel the display of a list of virtual objects in the virtual store in response to a trigger operation for the virtual store; and display a purchase interface of the virtual object in response to the trigger operation for the virtual store, and display a purchase prohibition window in response to a trigger operation for a purchase button in the purchase interface, or keep the purchase interface unchanged, the purchase prohibition window being configured to prompt that obtaining the virtual object or selling the virtual object is not supported.

In some embodiments, the foregoing first display unit 1602 includes:
a third display module, configured to display the first scene identifier and N scene identifiers when the first turn of the virtual game is entered, N being a positive integer, and the N scene identifiers being configured for indicating a scene where each of consecutive N turns after the first turn is situated.

The foregoing apparatus further includes:
a third display unit, configured to display M scene identifiers when a last turn of the consecutive N turns is ended and a next turn of the last turn is entered, M being a positive integer, the M scene identifiers being configured for indicating a scene where each of the consecutive M turns after the last turn is situated, scene identifiers in the M scene identifiers being at least partially different from scene identifiers in N+1 scene identifiers, and the N+1 scene identifiers including the first scene identifier and the N scene identifiers.

In some embodiments, the foregoing first display unit 1602 includes:
a fourth display module, configured to randomly select a first predetermined quantity of scene identifiers from a preset scene identifier set when the first turn of the virtual game is entered, to obtain the first scene identifier and the N scene identifiers, and display the first scene identifier and the N scene identifiers, the first predetermined quantity being equal to N+1.

The foregoing third display unit includes:
a second processing module, configured to randomly select a second predetermined quantity of scene identifiers from the scene identifier set when the last turn of the consecutive N turns is ended and the next turn of the last turn is entered, to obtain the M scene identifiers, and display the M scene identifiers, the second predetermined quantity being equal to M.

In some embodiments, the foregoing first processing unit 1606 includes:
a third processing module, configured to perform, in the first turn, an attack operation on the at least one virtual object in the combat area, the target operation including the attack operation.

In some embodiments, the foregoing third processing module includes:
a second processing submodule, configured to perform at least one of the following:
performing the attack operation on the at least one virtual object in the combat area at certain moments in the first turn;
performing the attack operation on the at least one virtual object situated in certain positions in the combat area in the first turn; and
performing the attack operation on the at least one virtual object situated in certain positions in the combat area at certain moments in the first turn.

In some embodiments, the foregoing certain moments are moments randomly determined in the first turn, and the certain positions are positions randomly determined in the combat area.

In some embodiments, the foregoing apparatus further includes:
a third processing unit, configured to prohibit, in the first scene of the first turn, the player account from obtaining the virtual object from the virtual store or selling the virtual object if it is predetermined in the virtual game that the player account is prohibited from obtaining the virtual object from the virtual store or selling the virtual object; or
predetermine, in the first scene of the first turn, that the player account is prohibited from upgrading or synthesizing the at least one virtual object in the combat area or the preparation area of the virtual game in the virtual game, and prohibit, in the first turn or in P turns, the player account from upgrading or synthesizing the at least one virtual object in the combat area or the preparation area of the virtual game, the P turns including a plurality of consecutive turns starting from the first turn, and P being a positive integer greater than or equal to 2.

In some embodiments, the foregoing first processing unit 1606 includes:
a fourth processing module, configured to add, when each of the at least one virtual object in the combat area has attributes of a combination type and effective quantities corresponding to the attributes of the combination type possessed by each virtual object, the effective quantities corresponding to the attributes of the combination type possessed by each of the at least one virtual object, to obtain a total effective quantity, and modify the effective quantity corresponding to the attribute of the combination type possessed by one of the at least one virtual object to the total effective quantity; and
set, when the effective quantity corresponding to the attribute of the combination type possessed by a p^{th} virtual object of the at least one virtual object is a p^{th} quantity, the attribute of the combination type possessed by the p^{th} virtual object to trigger release of a target skill or trigger adjustment of an attack value of the p^{th} virtual object when a quantity of virtual objects with a target type in the combat area is greater than or equal to the p^{th} quantity, the attack value being configured for indicating damage caused by the p^{th} virtual object performing the virtual attack operation, or trigger adjustment of a defense value of the p^{th} virtual object, the defense value being configured for indicating damage caused to the p^{th} virtual object when the p^{th} virtual object is subjected to the virtual attack operation, and p being a positive integer.

In some embodiments, the foregoing first scene identifier is a virtual weather identifier, and the first scene is a virtual weather represented by the first scene identifier; or
the first scene identifier is a virtual date identifier, and the first scene is a virtual date represented by the first scene identifier; or
the first scene identifier is a virtual subject identifier, and the first scene is a virtual subject represented by the first scene identifier.

The target operation in the first scene is performed on the at least one virtual object controlled by the player account based on the first scene identifier displayed on the game interface when the foregoing apparatus is applied to the first turn of the virtual game. In other words, with reference to a scene where a current turn is situated, different types of target operations may be performed on the virtual object in different scenes, thereby increasing diversity of operation forms, and achieving a technical effect of improving flexibility of a manner for controlling the virtual object.

For the embodiments of the apparatus for controlling a virtual object herein, reference may be made to the embodiments of the method for controlling a virtual object. Details are not described herein again.

According to yet another aspect of the embodiments of the present disclosure, an electronic device for implementing the foregoing method for controlling a virtual object is further provided. The electronic device may be a terminal device as shown in FIG. 17. In this embodiment of the present disclosure, a description is made by using an example in which the electronic device is a backend device. As shown in FIG. 17, the electronic device includes a memory 1702 and a processor 1704. The memory 1702 has a computer program stored therein. The processor 1704 is configured to perform the operations in any one of the foregoing method embodiments through the computer program.

In some embodiments, in this embodiment of the present disclosure, the foregoing electronic device may be situated in at least one of a plurality of network devices in a computer network.

In some embodiments, in this embodiment of the present disclosure, the foregoing processor may be configured to perform the following operations through a computer program.

S1: Display a combat area of a currently running virtual game, the virtual game being a TBG.

S2: Display a first scene identifier when a first turn of the virtual game is entered, the first scene identifier being configured for indicating a first scene where the first turn is situated.

S3: Perform a target operation on the at least one virtual object in the combat area in the first turn in when a game system of the virtual game is set to perform the target operation on at least one virtual object controlled by a player account in the combat area when the scene in the first turn is the first scene.

In some embodiments, a person skilled in the art may understand that the structure shown in FIG. 17 is merely an example, and the electronic device may also be a target terminal such as a smart phone (for example, an Android phone and an iOS phone), a tablet computer, a palmtop computer, a mobile Internet device (MID), a PAD, or the like. A structure of the foregoing electronic device is not limited in FIG. 17. For example, the electronic device may further include more or fewer components (for example, a network interface) than those shown in FIG. 17, or has a configuration different from that shown in FIG. 17.

The memory 1702 may be configured to store a software program and a module, for example, a program instruction or a module corresponding to the method and the apparatus for controlling a virtual object in the embodiments of the present disclosure. The processor 1704 executes the software program and the module stored in the memory 1702, to perform various function applications and data processing. In other words, the foregoing method for controlling a virtual object is implemented. The memory 1702 may include a high-speed random memory, and may also include a non-volatile memory, for example, one or more magnetic storage apparatuses, a flash memory, or another nonvolatile solid-state memory. In some embodiments, the memory 1702 may further include memories remotely arranged relative to the processor 1704, and the remote memories may be connected to a terminal through a network. Examples of the foregoing network include, but are not limited to, the Internet, an intranet, a local area network, a mobile communication network, and a combination thereof. The memory 1702 may be specifically, but is not limited to, being configured to store a first scene identifier, a game interface of a virtual game, a target operation, and the like. In an example, as shown in FIG. 17, the foregoing memory 1702 may include, but is not limited to, the first display unit 1602, the second display unit 1604, and the first processing unit 1606 in the foregoing apparatus for controlling a virtual object. In addition, the memory may further include, but is not limited to, another module unit in the apparatus for controlling a virtual object. Details are not described again in this example.

In some embodiments, a transmission apparatus 1706 is configured to receive or transmit data through a network. A specific example of the foregoing network may include a wired network and a wireless network. In an example, the transmission apparatus 1706 includes a network interface controller (NIC), which may be connected to another network device and a router through a network cable to communicate with the Internet or a local area network. In an example, the transmission apparatus 1706 is a radio frequency (RF) module, which is configured to communicate with the Internet in a wireless manner.

In addition, the foregoing electronic device further includes a display 1708 configured to display a first image and a second image, and a connection bus 1710 configured to connect various module components in the electronic device.

In some embodiments, the foregoing terminal device or the server may be a node in a distributed system. The distributed system may be a blockchain system. The blockchain system may be a distributed system formed through connection of a plurality of nodes in the form of network communication. A point-to-point network may be formed between the nodes. Any form of computing device, such as an electronic device including a server and a terminal, may become a node in the blockchain system by joining the point-to-point network.

According to still another aspect of the embodiments of the present disclosure, a computer program product or a computer program is provided, the computer program product or the computer program including a computer instruction, the computer instruction being stored in a computer-readable storage medium. A processor of a computer device reads the computer instruction from the computer-readable storage medium, and the processor executes the computer instruction, to cause the computer device to perform the method for controlling a virtual object provided in the various exemplary implementations of the foregoing server verification processing, and the like. The computer program, when being run, is configured to perform operations in the any one of the foregoing method embodiments.

In some embodiments, in this embodiment of the present disclosure, the foregoing computer-readable storage medium may be configured to store a computer program for performing the following operations.

S1: Display a combat area of a currently running virtual game, the virtual game being a TBG.

S2: Display a first scene identifier when a first turn of the virtual game is entered, the first scene identifier being configured for indicating a first scene where the first turn is situated.

S3: Perform a target operation on the at least one virtual object in the combat area in the first turn in when a game system of the virtual game is set to perform the target operation on at least one virtual object controlled by a player account in the combat area when the scene in the first turn is the first scene.

As such, according to various embodiments provided in the present disclosure, when the first turn of the virtual game is entered, the target operation in the first scene is performed on the at least one virtual object controlled by the player account based on the first scene identifier displayed on the game interface. Because a mechanism of the first scene is predetermined in the virtual game, the player does not need an additional operation to determine a scene or perform an operation, thereby reducing waiting time and simplifying an operation process. In other words, with reference to a scene where a current turn is situated, different types of target operations may be performed on the virtual object in different scenes, to automatically switch to a corresponding operation based on the different scenes, thereby reducing manual intervention and improving system running efficiency, helping properly allocate resources based on the different scenes, increasing diversity of operation forms, and achieving a technical effect of improving flexibility of a manner for controlling the virtual object.

In some embodiments, in the embodiments of the present disclosure, the term “module” or “unit” refers to a computer program having a predetermined function or a part of a computer program, and operates together with other relevant parts to achieve a predetermined objective, and may be all or partially implemented by using software, hardware (such as a processing circuit or a memory), or a combination thereof. Similarly, one processor (or a plurality of processors or memories) may be configured to implement one or more modules or units. In addition, each module or unit may be a part of an overall module or unit including a function of the module or unit.

In some embodiments, in the embodiments of the present disclosure, a person of ordinary skill in the art may understand that all or part of the operations of the various methods in the foregoing embodiments may be completed by a program instructing relevant hardware of a target terminal. The program may be stored in a computer-readable storage medium. The storage medium may include: a flash disk, a read-only memory (ROM), a random access memory (RAM), a magnetic disk, an optical disc, and the like.

The sequence numbers of the foregoing embodiments of the present disclosure are merely for description, and do not represent the preference of the embodiments.

When the integrated unit in the foregoing embodiment is implemented in a form of a software function unit and sold or used as an independent product, the integrated unit may be stored in the foregoing computer-readable storage medium. Based on such an understanding, the technical solutions of the present disclosure essentially, or the part contributing to the related art, or all or a part of the technical solutions may be implemented in a form of a software product. The computer software product is stored in a storage medium, and includes several instructions for enabling one or more computer devices (which may be a personal computer, a server, a network device, or the like) to perform all or a part of operations of the methods in the embodiments of the present disclosure.

In the embodiments of the present disclosure, the descriptions of the embodiments have respective emphasis. For a part not described in detail in an embodiment, reference may be made to related descriptions of other embodiments.

In the embodiments of the present disclosure, the disclosed client may be implemented in another manner. The apparatus embodiments described above are merely examples. For example, division of the units is merely division of logical functions, and may be another division during actual implementation. For example, a plurality of units or components may be combined or may be integrated into another system, or some features may be ignored or not performed. In addition, the displayed or discussed mutual coupling or direct coupling or communication connection may be implemented through some interfaces. The indirect coupling or communication connection between the units or modules may be implemented in electrical or another form.

The units described as separate components may or may not be physically separated, and the components displayed as units may or may not be physical units, which may be situated in one place, or may be distributed on a plurality of network units. Some or all of the units may be selected based on an actual requirement to implement the objectives of the solutions in embodiments of the present disclosure.

In addition, functional units in the embodiments of the present disclosure may be integrated into one processing unit, or each of the units may be physically separated, or two or more units may be integrated into one unit. The foregoing integrated unit may be implemented in a form of hardware, or may be implemented in a form of a software functional unit.

The foregoing are merely preferred implementations of the present disclosure. A person of ordinary skill in the art may further make several improvements and modifications without departing from the principle of the present disclosure, and these improvements and modifications also fall within the protection scope of the present disclosure.

What is claimed is:

1. A method for controlling a virtual object, applied to an electronic device, comprising:
displaying a combat area of a currently running virtual game, the virtual game being a turn-based game (TBG);
displaying a first scene identifier when a first turn of the virtual game is entered, the first scene identifier being configured for indicating a first scene where the first turn is situated; and
performing, in the first scene of the first turn if it is predetermined in the virtual game that a target operation is performed on at least one virtual object in the combat area, the target operation on the at least one virtual object in the combat area, the at least one virtual object being controlled by a player account.

2. The method according to claim 1, wherein performing the target operation on the at least one virtual object in the combat area comprises:
performing, in the first turn, an attribute adjustment operation on the at least one virtual object in the combat area, the attribute adjustment operation comprising at least one of following: adjusting an object attribute of the at least one virtual object in the first turn, adjusting a skill attribute of the at least one virtual object in the first turn, and adjusting an item attribute of the at least one virtual object in the first turn.

3. The method according to claim 2, wherein performing the attribute adjustment operation on the at least one virtual object in the combat area comprises at least one of following:
adjusting, in the first turn, at least one of an attack value and a defense value of the at least one virtual object in the combat area, the object attribute comprising at least one of the attack value and the defense value, the attack value being configured for indicating damage caused when the at least one virtual object performs a virtual attack operation in the first turn, and the defense value being configured for indicating damage caused to the at least one virtual object when the at least one virtual object is subjected to the virtual attack operation in the first turn;
adjusting, in the first turn, at least one of a quantity of skill release times and a skill cooling time of the at least one virtual object in the combat area, the skill attribute comprising at least one of the quantity of skill release times and the skill cooling time, the quantity of skill release times being configured for indicating a quantity of times the at least one virtual object is allowed to release a virtual skill in the first turn, and the skill cooling time being configured for indicating a waiting duration between a time when the at least one virtual object releases the virtual skill in the first turn and a time when the virtual skill is allowed to be released next time; and
adjusting, in the first turn, at least one of an item attack value and an item defense value of a virtual item used by the at least one virtual object in the combat area, the item attribute comprising at least one of the item attack value and the item defense value, the item attack value being configured for indicating damage caused by the at least one virtual object performing the virtual attack operation through the virtual item in the first turn, and the item defense value being configured for indicating damage caused to the at least one virtual object when the at least one virtual object using the virtual item is subjected to the virtual attack operation in the first turn.

4. The method according to claim 1, wherein displaying the first scene identifier when the first turn of the virtual game is entered comprises:
displaying the first scene identifier and N scene identifiers when the first turn of the virtual game is entered, N being a positive integer, the N scene identifiers being configured for indicating a scene where each of consecutive N turns after the first turn is situated, if the N scene identifiers comprise an i^{th} scene identifier and a j^{th} scene identifier, the i^{th} scene identifier is configured for indicating an i^{th} scene where an i^{th} turn of the consecutive N turns is situated, the j^{th} scene identifier is configured for indicating a j^{th} scene where a j^{th} turn of the consecutive N turns is situated, and the i^{th} scene is different from the j^{th} scene, the virtual game being configured to perform an i^{th} operation on an i^{th} group of virtual objects controlled by the player account in the combat area when the scene where the i^{th} turn is situated is the i^{th} scene, and being configured to perform a j^{th} operation on a j^{th} group of virtual objects controlled by the player account in the combat area when the scene where the j^{th} turn is situated is the j^{th} scene, i and j each being a positive integer less than or equal to N, and i being different from j; and
virtual objects in the i^{th} group of virtual objects being at least partially different from virtual objects in the j^{th} group of virtual objects, and the i^{th} operation being different from the j^{th} operation; or the virtual objects in the i^{th} group of virtual objects being at least partially different from the virtual objects in the i^{th} group of virtual objects, and the i^{th} operation being the same as the j^{th} operation; or the virtual objects in the i^{th} group of virtual objects being same as the virtual objects in the j^{th} group of virtual objects, and the i^{th} operation being different from the j^{th} operation.

5. The method according to claim 1, wherein
displaying the first scene identifier when the first turn of the virtual game is entered comprises: displaying the first scene identifier and N scene identifiers when the first turn of the virtual game is entered, N being a positive integer, and the N scene identifiers being configured for indicating a scene where each of consecutive N turns after the first turn is situated; and
the method further comprises:
prohibiting, when a k^{th} scene identifier in the N scene identifiers is configured for indicating a k^{th} scene where a k^{th} turn of the consecutive N turns is situated, and if it is predetermined in the virtual game that the player account is prohibited from obtaining the virtual object or selling the virtual object from or to a virtual store, the player account from obtaining the virtual object or selling the virtual object from or to the virtual store in the k^{th} turn, k being a positive integer less than or equal to N; or
prohibiting, when an r^{th} scene identifier in the N scene identifiers is configured for indicating an r^{th} scene where an r^{th} turn of the consecutive N turns is situated, and if it is predetermined in the virtual game that the player account is prohibited from upgrading or synthesizing at least one virtual object in the combat area or a preparation area of the virtual game, the player account from upgrading or synthesizing the at least one virtual object in the combat area or the preparation area of the virtual game in the r^{th} turn or in R turns, r being a positive integer less than or equal to N, the R turns comprising a plurality of consecutive turns starting from the r^{th} turn, and R being a positive integer greater than or equal to 2.

6. The method according to claim 5, further comprising:
prohibiting the player account from obtaining the virtual object or selling the virtual object from or to the virtual store in the following manners:
setting a display style of the virtual store to a locked state, and cancelling a display of a list of virtual objects in the virtual store in response to a trigger operation for the virtual store; and
displaying a purchase interface of the virtual object in response to the trigger operation for the virtual store, and displaying a purchase prohibition window in response to a trigger operation for a purchase button in the purchase interface, or keeping the purchase interface unchanged, the purchase prohibition window being configured to prompt that obtaining the virtual object or selling the virtual object is not supported.

7. The method according to claim 1, wherein
displaying the first scene identifier when a first turn of the virtual game is entered comprises: displaying the first scene identifier and N scene identifiers when the first turn of the virtual game is entered, N being a positive integer, and the N scene identifiers being configured for indicating a scene where each of consecutive N turns after the first turn is situated; and
the method further comprises: displaying M scene identifiers when a last turn of the consecutive N turns is ended and a next turn of the last turn is entered, M being a positive integer, the M scene identifiers being configured for indicating a scene where each of the consecutive M turns after the last turn is situated, scene identifiers in the M scene identifiers being at least partially different from scene identifiers in N+1 scene identifiers, and the N+1 scene identifiers comprising the first scene identifier and the N scene identifiers.

8. The method according to claim 7, wherein
displaying the first scene identifier and the N scene identifiers when the first turn of the virtual game is entered comprises: randomly selecting a first predetermined quantity of scene identifiers from a preset scene identifier set when the first turn of the virtual game is entered, to obtain the first scene identifier and the N scene identifiers, and displaying the first scene identifier and the N scene identifiers, the first predetermined quantity being equal to N+1; and
the displaying of the M scene identifiers when a last turn of the consecutive N turns is ended and a next turn of the last turn is entered comprises: randomly selecting a second predetermined quantity of scene identifiers from the scene identifier set when the last turn of the consecutive N turns is ended and the next turn of the last turn is entered, to obtain the M scene identifiers, and displaying the M scene identifiers, the second predetermined quantity being equal to M.

9. The method according to claim 1, wherein performing the target operation on the at least one virtual object in the combat area comprises:
performing, in the first turn, an attack operation on the at least one virtual object in the combat area, the target operation comprising the attack operation.

10. The method according to claim 9, wherein performing the attack operation on the at least one virtual object in the combat area comprises one of following:
performing the attack operation on the at least one virtual object in the combat area at certain moments in the first turn;
performing the attack operation on the at least one virtual object situated in certain positions in the combat area in the first turn; and
performing the attack operation on the at least one virtual object situated in certain positions in the combat area at certain moments in the first turn.

11. The method according to claim 10, wherein the certain moments are moments randomly determined in the first turn, and the certain positions are positions randomly determined in the combat area.

12. The method according to claim 1, further comprising:
prohibiting, in the first scene of the first turn, the player account from obtaining the virtual object from the virtual store or selling the virtual object if it is predetermined in the virtual game that the player account is prohibited from obtaining the virtual object from the virtual store or selling the virtual object; or
predetermining, in the first scene of the first turn, that the player account is prohibited from upgrading or synthesizing the at least one virtual object in the combat area or the preparation area of the virtual game in the virtual game, and prohibiting, in the first turn or in P turns, the player account from upgrading or synthesizing the at least one virtual object in the combat area or the preparation area of the virtual game, the P turns comprising a plurality of consecutive turns starting from the first turn, and P being a positive integer greater than or equal to 2.

13. The method according claim 1, wherein performing the target operation on the at least one virtual object in the combat area comprises:
adding, when each of the at least one virtual object in the combat area has attributes of a combination type and effective quantities corresponding to the attributes of the combination type possessed by each virtual object, the effective quantities corresponding to the attributes of the combination type possessed by each of the at least one virtual object, to obtain a total effective quantity, and modifying the effective quantity corresponding to the attribute of the combination type possessed by one of the at least one virtual object to the total effective quantity; and
setting, when the effective quantity corresponding to the attribute of the combination type possessed by a p^{th} virtual object of the at least one virtual object is a p^{th} quantity, the attribute of the combination type possessed by the p^{th} virtual object to trigger release of a target skill or trigger adjustment of an attack value of the p^{th} virtual object when a quantity of virtual objects with a target type in the combat area is greater than or equal to the p^{th} quantity, the attack value being configured for indicating damage caused by the p^{th} virtual object performing the virtual attack operation, or trigger adjustment of a defense value of the p^{th} virtual object, the defense value being configured for indicating damage caused to the p^{th} virtual object when the p^{th} virtual object is subjected to the virtual attack operation, and p being a positive integer.

14. The method according to claim 1, wherein
the first scene identifier is a virtual weather identifier, and the first scene is a virtual weather represented by the first scene identifier; or
the first scene identifier is a virtual date identifier, and the first scene is a virtual date represented by the first scene identifier; or
the first scene identifier is a virtual subject identifier, and the first scene is a virtual subject represented by the first scene identifier.

15. An electronic device, comprising:
one or more processors and a memory containing a computer program that, when being executed, causes the one or more processors to perform:
displaying a combat area of a currently running virtual game, the virtual game being a turn-based game (TBG);
displaying a first scene identifier when a first turn of the virtual game is entered, the first scene identifier being configured for indicating a first scene where the first turn is situated; and
performing, in the first scene of the first turn if it is predetermined in the virtual game that a target operation is performed on at least one virtual object in the combat area, the target operation on the at least one virtual object in the combat area, the at least one virtual object being controlled by a player account.

16. The electronic device according to claim 15, wherein the one or more processors are further configured to perform:
performing, in the first turn, an attribute adjustment operation on the at least one virtual object in the combat area, the attribute adjustment operation comprising at least one of following: adjusting an object attribute of the at least one virtual object in the first turn, adjusting a skill attribute of the at least one virtual object in the first turn, and adjusting an item attribute of the at least one virtual object in the first turn.

17. The electronic device according to claim 16, wherein the one or more processors are further configured to perform at least one of following:
adjusting, in the first turn, at least one of an attack value and a defense value of the at least one virtual object in the combat area, the object attribute comprising at least one of the attack value and the defense value, the attack value being configured for indicating damage caused when the at least one virtual object performs a virtual attack operation in the first turn, and the defense value being configured for indicating damage caused to the at least one virtual object when the at least one virtual object is subjected to the virtual attack operation in the first turn;
adjusting, in the first turn, at least one of a quantity of skill release times and a skill cooling time of the at least one virtual object in the combat area, the skill attribute comprising at least one of the quantity of skill release times and the skill cooling time, the quantity of skill release times being configured for indicating a quantity of times the at least one virtual object is allowed to release a virtual skill in the first turn, and the skill cooling time being configured for indicating a waiting duration between a time when the at least one virtual object releases the virtual skill in the first turn and a time when the virtual skill is allowed to be released next time; and
adjusting, in the first turn, at least one of an item attack value and an item defense value of a virtual item used by the at least one virtual object in the combat area, the item attribute comprising at least one of the item attack value and the item defense value, the item attack value being configured for indicating damage caused by the at least one virtual object performing the virtual attack operation through the virtual item in the first turn, and the item defense value being configured for indicating damage caused to the at least one virtual object when the at least one virtual object using the virtual item is subjected to the virtual attack operation in the first turn.

18. The electronic device according to claim 15, wherein the one or more processors are further configured to perform:
displaying the first scene identifier and N scene identifiers when the first turn of the virtual game is entered, N being a positive integer, the N scene identifiers being configured for indicating a scene where each of consecutive N turns after the first turn is situated, if the N scene identifiers comprise an i^{th} scene identifier and a j^{th} scene identifier, the i^{th} scene identifier is configured for indicating an i^{th} scene where an i^{th} turn of the consecutive N turns is situated, the j^{th} scene identifier is configured for indicating a j^{th} scene where a j^{th} turn of the consecutive N turns is situated, and the i^{th} scene is different from the j^{th} scene, the virtual game being configured to perform an i^{th} operation on an i^{th} group of virtual objects controlled by the player account in the combat area when the scene where the i^{th} turn is situated is the i^{th} scene, and being configured to perform a j^{th} operation on a j^{th} group of virtual objects controlled by the player account in the combat area when the scene where the j^{th} turn is situated is the j^{th} scene, i and j each being a positive integer less than or equal to N, and i being different from j; and
virtual objects in the i^{th} group of virtual objects being at least partially different from virtual objects in the j^{th} group of virtual objects, and the i^{th} operation being different from the j^{th} operation; or the virtual objects in the i^{th} group of virtual objects being at least partially different from the virtual objects in the i^{th} group of virtual objects, and the i^{th} operation being the same as the j^{th} operation; or the virtual objects in the i^{th} group of virtual objects being same as the virtual objects in the j^{th} group of virtual objects, and the i^{th} operation being different from the j^{th} operation.

19. The electronic device according to claim 15, wherein the one or more processors are further configured to perform:
displaying the first scene identifier and N scene identifiers when the first turn of the virtual game is entered, N being a positive integer, and the N scene identifiers being configured for indicating a scene where each of consecutive N turns after the first turn is situated; and
prohibiting, when a k^{th} scene identifier in the N scene identifiers is configured for indicating a k^{th} scene where a k^{th} turn of the consecutive N turns is situated, and if it is predetermined in the virtual game that the player account is prohibited from obtaining the virtual object or selling the virtual object from or to a virtual store, the player account from obtaining the virtual object or selling the virtual object from or to the virtual store in the k^{th} turn, k being a positive integer less than or equal to N; or
prohibiting, when an r^{th} scene identifier in the N scene identifiers is configured for indicating an r^{th} scene where an r^{th} turn of the consecutive N turns is situated, and if it is predetermined in the virtual game that the player account is prohibited from upgrading or synthesizing at least one virtual object in the combat area or a preparation area of the virtual game, the player account from upgrading or synthesizing the at least one virtual object in the combat area or the preparation area of the virtual game in the r^{th} turn or in R turns, r being a positive integer less than or equal to N, the R turns comprising a plurality of consecutive turns starting from the r^{th} turn, and R being a positive integer greater than or equal to 2.

20. A non-transitory computer readable storage medium containing a computer program that, when being executed, causes at least one processor to perform:
displaying a combat area of a currently running virtual game, the virtual game being a turn-based game (TBG);
displaying a first scene identifier when a first turn of the virtual game is entered, the first scene identifier being configured for indicating a first scene where the first turn is situated; and
performing, in the first scene of the first turn if it is predetermined in the virtual game that a target operation is performed on at least one virtual object in the combat area, the target operation on the at least one virtual object in the combat area, the at least one virtual object being controlled by a player account.
